(19) United States
(12) Patent Application Publication
(10) Pub. No.: US 2011/0243584 A1
(43) Pub. Date: Oct. 6, 2011

(54) DEVELOPING DEVICE

(75) Inventor: Tadashi Fukuda, Toride-shi (JP)

(73) Assignee: CANON KABUSHIKI KAISHA, Tokyo (JP)

(21) Appl. No.: 13/077,238

(22) Filed: Mar. 31, 2011

(30) Foreign Application Priority Data
Apr. 2, 2010 (JP) 2010-085769

(51) Int. Cl. G03G 15/08

(52) U.S. Cl. 399/30; 399/254

(57) ABSTRACT

A developing device includes a developing container for containing a developer including toner and a carrier, a feeding member for feeding the developer in the developing container through a feeding path, and a detecting portion for detecting information on magnetic permeability of the developer in the developing container. A cross-section of said feeding path includes a first area and a second area which has a larger height than that of the first area, and said detection portion is provided vertically below the first area.

### FIELD OF THE INVENTION AND RELATED ART

The present invention relates to a developing device for use with an image forming apparatus, using an electrophotographic process, such as a copying machine, a facsimile machine or a printer.

FIG. 9 is an illustration of a conventional developing device 32. As shown in FIG. 9, the conventional developing device 32 includes a developing container 31 partitioned into a developing chamber R1 as a developer flow path and a stirring chamber R2 by a partition wall 44. The developing chamber R1 and the stirring chamber R2 are provided with stirring and feeding screws (feeding members) 36 and 37, respectively, which are rotatable. At an opening 30 of the developing chamber R1, a developing sleeve 38 which rotates in a predetermined direction is provided. The developing sleeve 38 is disposed opposed to a photosensitive drum 3, which rotates in a predetermined direction, with a small gap therebetween. Inside the developing sleeve 38, a magnet 29 is fixed.

Toner in an amount corresponding to the amount of the toner consumed by development is supplied from a toner storing chamber (not shown), in which toner for supply is stored, into the stirring chamber R2. The supplied toner is mixed with a developer 35 in the developer container 31 by a screw 37 and is fed by the screw 37. A developer feeding direction of a screw 36 in the developing chamber R1 and that of the screw 37 in the stirring chamber R2 are opposite from each other. At each of a front side and rear side of the partition wall 44 in FIG. 9, an opening is provided. Through these (two) openings, the developer 35 is transferred between the developing chamber R1 and the stirring chamber R2.

In the developer container 31, the developer 35 prepared by mixing toner particles and a magnetic carrier is contained. A volume mixing ratio of toner particles T to a magnetic carrier C in the developer is referred to as a T/C ratio. It is very important that the T/C ratio of the two-component developer in the developer container is maintained for stabilizing an output image. A magnetic permeability (detecting sensor 43 is provided in the stirring chamber R2 and detects magnetic permeability of the developer 35 in a certain volume on a detection surface (detecting portion) 43 by utilizing inductance. The magnetic permeability sensor 43 is capable of directly detecting the T/C ratio and is less influenced by contamination due to toner scattering. Further, the sensor itself is inexpensive, so that a cost can be reduced.

In the case where the magnetic permeability of the developer 35 in the certain volume is large, the magnetic permeability sensor 43 judges that the T/C ratio of the developer 35 is lowered and then toner supply is started. On the other hand, in the case where the magnetic permeability is small, the magnetic permeability sensor 43 judges that the T/C ratio of the developer 35 is increased and then the toner supply is stopped.

On the basis of such a sequence, the T/C ratio of the developer 35 is controlled.

However, the magnetic permeability sensor 43 detects the magnetic permeability in the certain volume and therefore when a bulk density of the developer 35 varies due to continuous image formation or the like, the magnetic permeability in the certain volume is changed and therefore accurate detection of the T/C ratio cannot be performed.

For this reason, in Japanese Laid-Open Patent Application (JP-A) 2003-307918, as shown in (a) and (b) of FIG. 10, a first area 70 of a ceiling of a feeding path is lowered at a portion where the magnetic permeability sensor 43 is provided, and a developer flow path is narrowed compared with other areas. Part (a) of FIG. 10 is a sectional view of the conventional developing device taken along X-X line indicated in FIG. 9. Part (b) of FIG. 10 is a sectional view of the conventional developing device taken along Y-Y line indicated in FIG. 9. That is, (b) of FIG. 10 is a longitudinal sectional view as seen from Z direction. The first area 70 is provided over the flow path with respect to a widthwise direction perpendicular to a feeding direction of the developer 35. By narrowing the developer flow path, a fluctuation in bulk density of the developer is suppressed and thus erroneous detection by the magnetic permeability sensor 43 is suppressed. However, in JP-A 2003-307918, the developer flow path is narrowed and therefore it becomes difficult to uniformly circulate the developer. At an upstream side of the first area 70 where a height of the ceiling is lowered, surface of the developer is liable to occur. Flow ability and bulk density of the developer are changed every moment depending on a disposing environment, the number of sheets subjected to continuous image formation and status of use. For that reasons, in a feeding path such that only a part thereof is narrowed, it is difficult to constantly circulate the developer through the continuous image formation. When the circulation of the developer becomes bad, supply of the developer 35 to the developing sleeve 38 becomes unstable and thus there is a possibility that image defect such as decrease or non-uniformity of image density occurs.

More specifically, at an initial stage of use, the developer 35 has high flowability and therefore is fed smoothly even at the portion where the flow path is narrowed. For that reason, the stagnation does not occur also at the upstream side of the first area 70 where the height of the ceiling is lowered, so that an initial developer surface height 500 (indicated by a solid line of (b) of FIG. 10) is constant with respect to the feeding direction. However, at a later stage of use, on an upstream side of the first area 70 in which flowability of the developer 35 is lowered and the height of the ceiling is lowered, stagnation occurs and thus a developer surface height 501 (indicated by a dotted line of (b) of FIG. 10) is not uniform.

Further, when the stagnation of the developer occurs at an intermediate position of the flow path, the toner is not moved and thus is agglomerated. When the agglomerated toner is conveyed to the developing sleeve 38 accidentally by vibration or the like and is subjected to the development, there is a possibility that image defect occurs due to aggregate of the toner.

### SUMMARY OF THE INVENTION

A principal object of the present invention is to provide a developing device capable of suppressing an occurrence of image defect by keeping a circulation state of a developer in a developer container while enhancing detection accuracy of a magnetic permeability sensor.

According to an aspect of the present invention, there is provided a developing device comprising:

a developing container for containing a developer including toner and a carrier;

a feeding member for feeding the developer in said developing container through a feeding path; and

a detecting portion for detecting information on magnetic permeability of the developer in said developing container,

wherein a cross-section of the feeding path includes a first area and a second area which has a larger height than that of the first area, and the detection portion is provided vertically below the first area.

In the cross-section of the feeding path, a ceiling of the first area is below a level (surface height) of the developer in the second area when said feeding member is in operation.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic view of a developing device according to First Embodiment.

Part (a) of FIG. 2 is a sectional view of the developing device in First Embodiment taken along X-X line indicated in FIG. 1, and (b) of FIG. 2 is a sectional view of the developing device in First Embodiment taken along Y-Y line indicated in FIG. 1.

FIG. 3 is a schematic view of an image forming apparatus.

Part (a) of FIG. 4 is a schematic view showing a positional relationship between a magnetic permeability sensor and a ceiling, and (b) of FIG. 4 is another schematic view showing a positional relationship between the magnetic permeability sensor and the ceiling.

FIG. 5 is a comparison graph of an erroneous detection ratio of the magnetic permeability sensor.

Part (a) of FIG. 6 is a schematic view showing a positional relationship between the magnetic permeability sensor and a developer surface height, and (b) of FIG. 6 is a graph showing a relationship between pressure and the developer surface height with respect to the magnetic permeability sensor.

FIG. 7 is a schematic view of a developing device according to Second Embodiment.

Part (a) of FIG. 8 is a sectional view of the developing device in Second Embodiment taken along X-X line indicated in FIG. 7, and (b) of FIG. 2 is a sectional view of the developing device in Second Embodiment taken along Y-Y line indicated in FIG. 7.

FIG. 9 is a schematic view of a conventional developing device.

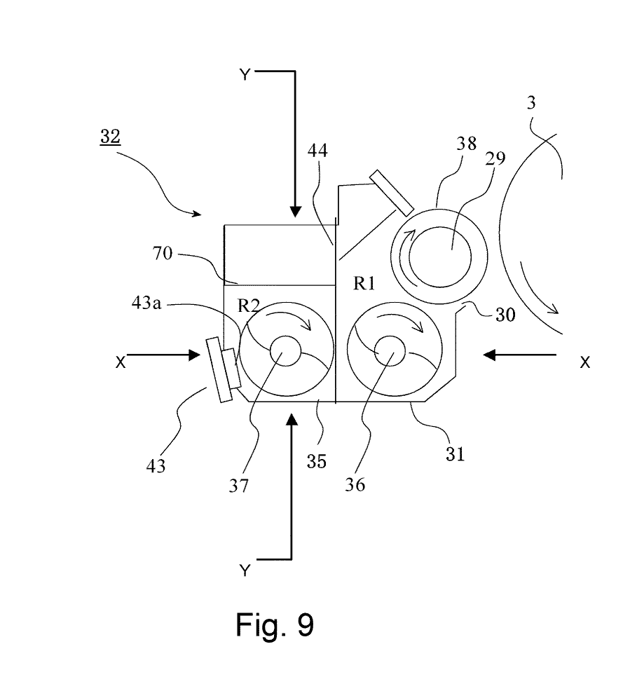

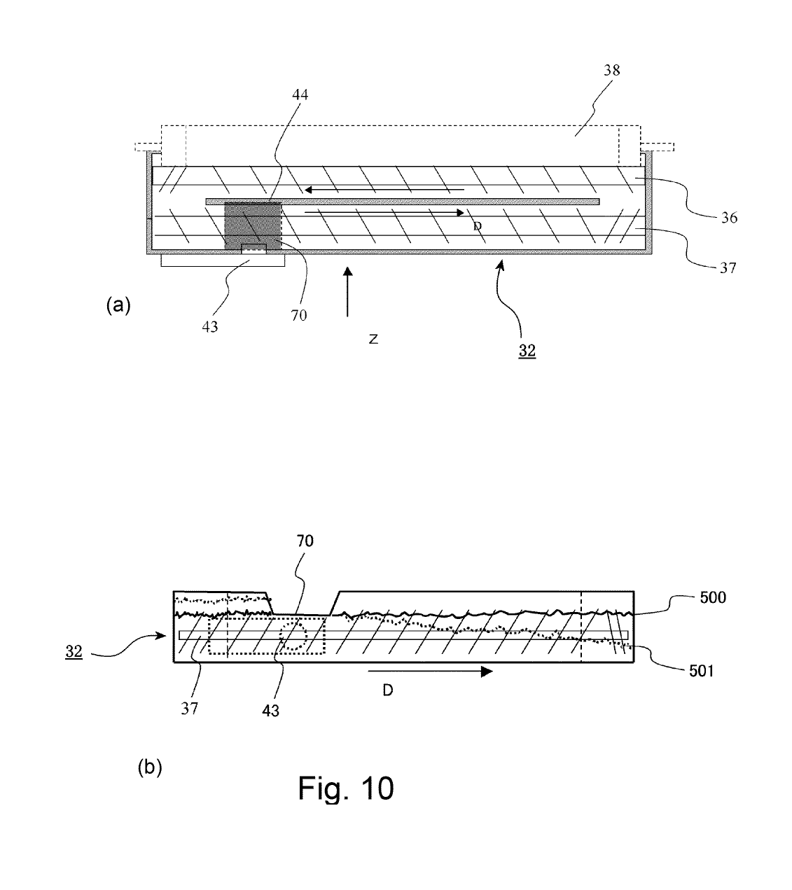

Part (a) of FIG. 10 is a sectional view of the conventional developing device taken along X-X line indicated in FIG. 9, and (b) of FIG. 10 is a sectional view of the conventional developing device taken along Y-Y line indicated in FIG. 9.

### DESCRIPTION OF THE PREFERRED EMBODIMENTS

### First Embodiment

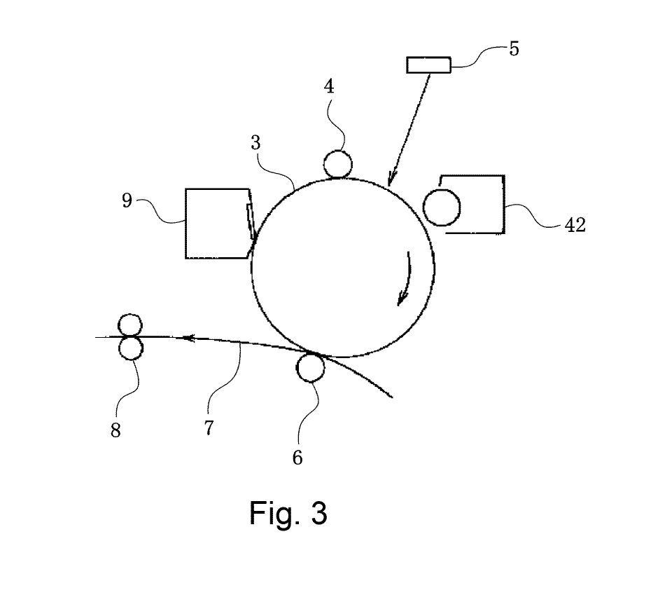

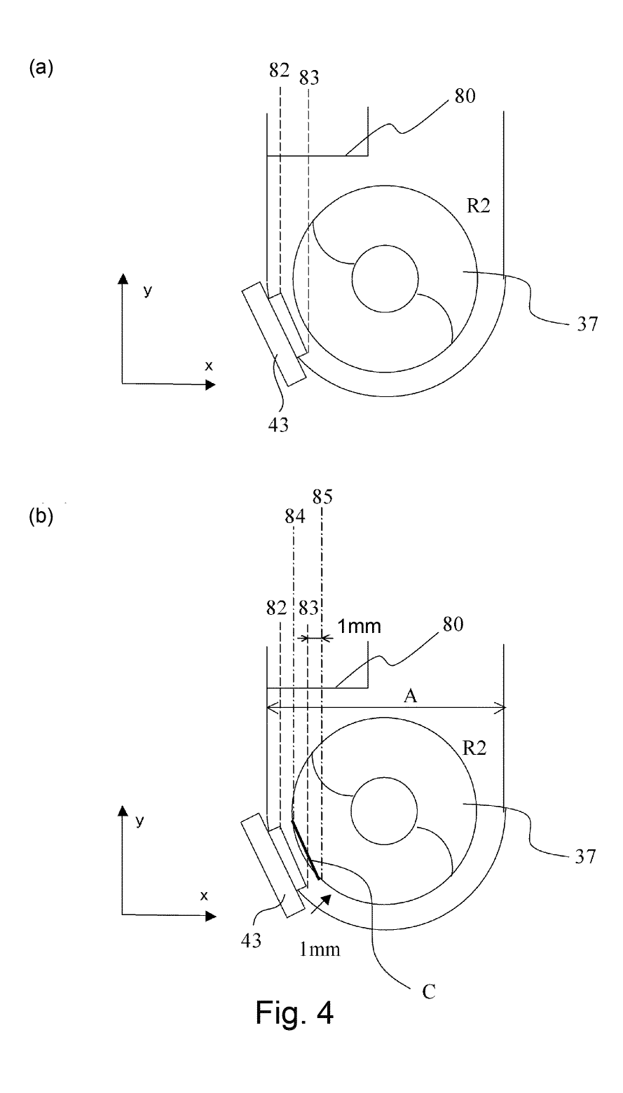

First Embodiment of a developing device according to the present invention will be described with reference to the drawings. FIG. 3 is a schematic view of an electrophotographic image forming apparatus. As shown in FIG. 3, the image forming apparatus includes a photosensitive drum (image bearing member) 3 provided rotatably and a primary charger 4 which electrically charges the photosensitive drum 3 uniformly. The charged photosensitive drum 3 is exposed to light such as laser light corresponding to image information by a light emitting device 5, so that an electrostatic latent image is formed. The electrostatic latent image is developed with a developer 35 by a developing device 42, thus being visualized as a visible image (toner image). The toner image is transferred onto a sheet 7 by a transfer charger 6 and is fixed by a fixing device 8. Transfer residual toner remaining on the photosensitive drum 3 after the transfer is removed by a cleaning device 9.

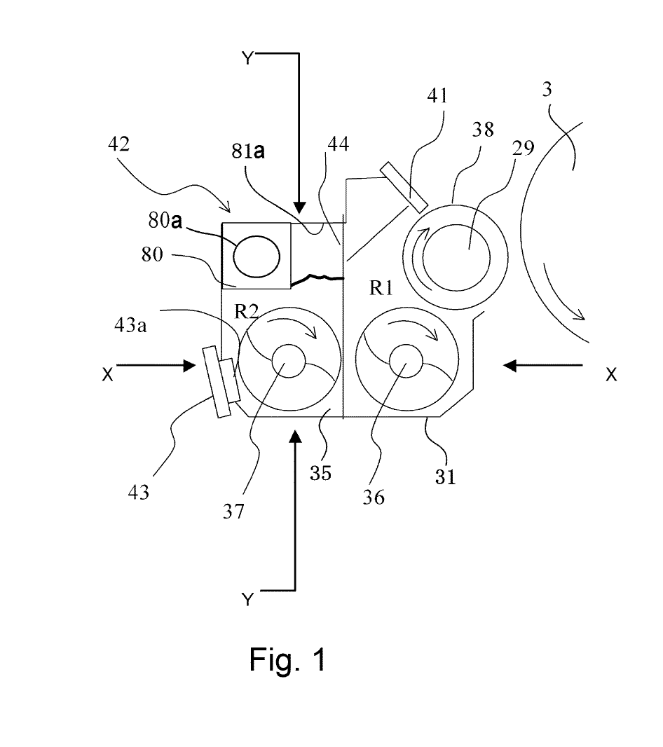

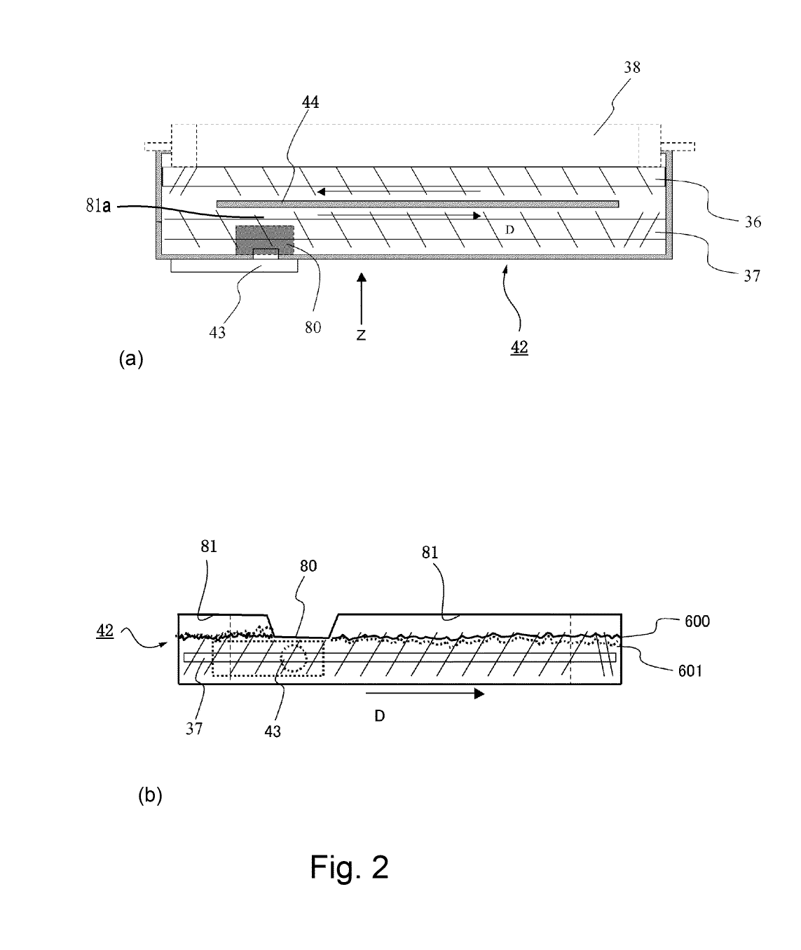

FIG. 1 is a schematic view of the developing device 42. As shown in FIG. 1, the developing device 42 includes a developer container 31 which is partitioned by a partition wall 44 into a developing chamber R1 which is a developer flow path and a stirring chamber R2. In the developing chamber R1 and the stirring chamber R2, stirring and feeding screws (feeding members) 36 and 37 are rotatably provided, respectively. At an opening 30 of the developing chamber R1, a developing sleeve (developer carrying member) 38 to be rotated in an arrow direction at a peripheral speed Vb is provided. The developing sleeve 38 is disposed opposed to the photosensitive drum 3, to be rotated in an arrow direction at a peripheral speed Va, with a small gap. Inside the developing sleeve 38, the developer 35 is regulated in a proper layer thickness by a layer thickness regulating blade 41 provided at an upper end of the opening of the developer container 31 and thereafter is carried and fed to a developing area. In the developing area, a magnetic brush of the developer carried on the developing sleeve 38 is contacted to the photosensitive drum 3, so that the electrostatic latent image is developed.

Toner in an amount corresponding to the amount of the toner consumed by the development is supplied from toner storing chamber (not shown), which stores toner for supply, into the stirring chamber R2. In this embodiment, a first area 80 also functions as a feeding path 80a in which the toner for supply is fed to the stirring chamber R2, and a bottom of the feeding path 80a forms the first area 80. As a result, in a constitution in which the toner for supply is dropped from above the stirring chamber R2, downsizing with respect to vertical direction can be effectively realized.

The supplied toner is mixed with the developer 35 in the developer container 31 by stirring with the screw 37 in the stirring chamber R2 and is fed. A developer feeding direction of the screw 36 in the developing chamber R1 and that of the screw 37 in the stirring chamber R2 are opposite from each other. The partition wall 44 is provided with an opening on each of a front side and a rear side in FIG. 1. Through these (two) openings, the developer 35 is transferred between the developing chamber R1 and the stirring chamber R2.

In the developer container 31, the developer 35 prepared by mixing toner particles T and a magnetic carrier C is stored. A volume mixing ratio of the toner particles T to the magnetic carrier C is referred to as a T/C ratio. It is very important that the T/C ratio of the two-component developer in the developer container is maintained. A magnetic permeability sensor (toner content detecting means) 43 is provided in the stirring chamber R2 and has a detection surface (detecting portion) 43a. The detection surface 43a outputs, as a detection result, information on magnetic permeability of a certain volume of the developer 35 on the developer surface 43a, and on the basis of this output the magnetic permeability sensor 43 detects information on toner content by utilizing inductance. The magnetic permeability sensor 43 can directly detect the T/C ratio and is not influenced by contamination due to toner scattering. Further, the magnetic permeability sensor 43 alone is inexpensive, so that cost can be suppressed.

The magnetic permeability sensor 43 judges, in the case where the magnetic permeability of the developer 35 in a certain volume is increased, that the T/C ratio of the developer 35 is lowered, and then toner supply is started. On the other hand, in the case where the magnetic permeability is decreased, the magnetic permeability sensor 43 judges that the T/C ratio of the developer 35 is increased, and then the toner supply is stopped. Based on such a sequence, the T/C ratio of the developer 35 is controlled.

The magnetic permeability sensor 43 is obliquely disposed on a side surface of the stirring chamber R2 and at a position close to the screw 37. Incidentally, the magnetic permeability sensor 43 may only be required to be disposed at a position in which the thickness of the developer 35 to the extent that the toner content detection can be performed at the detection surface 43a can be ensured and in which the developer can flow during rotation of the screw 37. For example, the magnetic permeability sensor 43 may be provided vertically on the side surface of the stirring chamber R2 and may also be provided horizontally on the bottom of the stirring chamber R2. Further, the magnetic permeability sensor 43 can be freely disposed with respect to a developer feeding direction.

Part (a) of FIG. 2 is a sectional view of the developing device 42 taken along X-X line indicated in FIG. 1, and (b) of FIG. 2 is a sectional view of the developing device 42 taken along Y-Y line indicated in FIG. 1. The direction in which the developer is fed is indicated by an arrow D. As shown in FIG. 1 and (a) of FIG. 2, in this embodiment, in place of the conventional first area 70, the first area 80 is provided. The first area 80 is provided above the portion where the magnetic permeability sensor 43 is provided and as shown in FIG. 1 and (b) of FIG. 2, is provided so as to be lower than the height of the ceiling at other portions. The height of the first area 80 may only be required that the developer 35 is contacted to the first area 80 from the initial stage of use through the later stage of use in which the flowability of the developer 35 is lowered and thus a bulk density of the developer 35 is constant.

By providing the first area 80, the developer flow path below the first area 80 is narrowed compared with other areas (ceiling 81 and second area 81a). As a result, the developer 35 is fed below the first area 80 at a constant bulk density, so that a fluctuation in bulk density can be suppressed. As a result, it is possible to suppress erroneous detection of the magnetic permeability sensor 43 due to the fluctuation in bulk density.

Specifically, the developer 35 is contacted to the first area 80, so that pressure at a certain degree or more is applied to the magnetic permeability sensor 43. As a result, the bulk density of the developer becomes constant, so that the erroneous detection of the magnetic permeability sensor 43 can be suppressed even when a physical property of the developer 35 is changed.

The pressure at the magnetic permeability sensor 43 was measured by a pressure sensor manufactured by FISO Technologies, Inc. A relationship between the pressure at the magnetic permeability sensor 43 and the developer surface height will be described with reference to (a) and (b) of FIG. 6. Part (a) of FIG. 6 is a schematic view showing a positional relationship between the magnetic permeability sensor and the developer surface height, and (b) of FIG. 6 is a graph showing the relationship between the pressure at the magnetic permeability sensor and the developer surface height. Incidentally, the pressure at the magnetic permeability sensor varies depending on the type of the developer, a constitution of the developer container, a diameter of the magnetic permeability sensor, and the like, so that the relationship is shown in the graph by relative values. The developer surface height is, as shown in (a) of FIG. 6, measured in a manner such that the height of the container bottom of the stirring chamber R2 is taken as 0 (zero) and is increased as a positive value in a vertically upward direction.

As shown in (a) of FIG. 6, the pressure at the magnetic permeability sensor was measured when the developer surface height is gradually increased in the order of heights h1, h2 and h3. As shown in (b) of FIG. 6, the pressure at the magnetic permeability sensor is proportionally increased in the order of heights h1, h2 and h3. When the developer surface height of the first area 80 reaches a certain developer surface height H, the pressure becomes constant. This is because the first area 80 is not provided over the entire widthwise direction of the feeding flow path but is partly provided above the feeding flow path with respect to the widthwise direction and thus is escaped. By adjusting the amount of the developer 35 so that the developer surface height is constant at the developer surface height H with respect to the feeding flow path, the pressure from the developer to the magnetic permeability sensor 43 becomes constant, so that detection accuracy of the magnetic permeability sensor 43 is enhanced.

The first area 80 is provided from one end of the developer container 31 to an intermediate position of the feeding flow path with respect to the widthwise direction perpendicular to the feeding direction of the developer 35. With respect to the widthwise direction of the feeding flow path, the ceiling height of the second area 81a free from the first area 80 is higher than the developer surface height and constitutes a ceiling with a normal height at which the developer 35 is not contacted to the ceiling. The developer 35 which is liable to be stagnated on the upstream side of the first area 80 is liable to be fed from below the second area 81a. At the first area 80 side, as shown in FIG. 1, the developer 35 is contacted to the first area 80. On the other hand, at the second area 81a side, the developer 35 is fed without being regulated by the second area 81a.

As a result, as shown in (b) of FIG. 2, both of a developer surface height 600 (solid line) at the initial stage of use and a developer surface height 601 (dotted line) after continuous use can be kept at a constant level with no stagnation of the developer 35 at the upstream side of the first area 80.

Thus, from the initial stage of use through the later stage of use, the developer 35 can be circulated uniformly and can be stably fed to the developing sleeve 38, so that an occurrence of the image defect due to the toner aggregation can be suppressed. Further, the occurrence of the image defect such as a decrease in image density or non-uniformity of the image density can be suppressed.

Incidentally, whether or not the developer is contacted to the ceiling was judged by stopping the feeding screw every phase of 30 degrees and then by measuring the developer surface height. Depending on the shape of the feeding screw, a feeding state of the developer varies and thus the developer surface height varies. In order to measure an average value of the developer surface height in a distance corresponding to one full circumference of the feeding screw in view of the influence of the variations, the developer surface height every 30 degrees is measured. When the developer at 7 points or more of 12 points of the developer surface height measured every 30 degrees are contacted to the ceiling, the developer is judged that it is contacted to the ceiling. In this embodiment, in the case where the developer is contacted to the ceiling at 7 points or more when the developer surface height is measured in the above-described manner, the position of the ceiling is judged that it is lower than the developer surface height. Further, in the case where the developer is contacted to the ceiling at less than 3 points when the developer surface height is measured in the above-described manner, the height (position) of the ceiling is judged that it is higher than the developer surface height.

### (Positional Relationship Between Detection Surface 43a of Magnetic Permeability Sensor 43 and First Area 80)

Here, the positional relationship between the detection surface 43a of the magnetic permeability sensor 43 and the first area 80 will be described.

Part (a) of FIG. 4 is a sectional view showing a relationship between the magnetic permeability sensor 43 and the first area 80. Broken lines 82 and 83 extended vertically from the detection surface 43a of the magnetic permeability sensor 43 to above the detection surface 43a in a gravitational direction (y direction in (a) of FIG. 4) are required to cross the firs area 80. That is, the detection surface 43a is required to be disposed vertically below the first area 80.

As shown in (b) of FIG. 4, when a detection surface C obtained by parallelly shifting the detection surface 43a of the magnetic permeability sensor 43 to the side of the developer, to be developed, by 1 mm is assumed and when chain lines 84 and 85 upwardly extended vertically in the gravitational direction overlap with the first area 80 with respect to x direction, the detection accuracy is further enhanced. That is, when the first area 80 is present in a range wider by about 1 mm from the position vertically above the detection surface 43a of the magnetic permeability sensor 43, the detection accuracy is further enhanced. For example, a detection error in (a) of FIG. 4 is 0.5%. On the other hand, in (b) of FIG. 4 in which the length of the first area 80 is extended by 1 mm in the widthwise direction of the feeding flow path, the detection error was 0.4% and thus the detection accuracy was enhanced. Incidentally, the detection error in the case where there was no first area 80 was 1.5%. A measuring method of the detection error will be described later. In this embodiment, with respect to the widthwise direction of the feeding flow path, in the stirring chamber R2, a flow path width A is 20 mm, the first area 80 is 8 mm in length and the second area 81a is 12 mm in length. The length of the first area 80 with respect to the widthwise direction of the feeding flow path may preferably be 70% or less, more preferably 50% or less, of the length of the stirring chamber R2 in the widthwise direction. This is because when the length exceeds 80%, the circulation of the developer 35 becomes nonuniform similarly as in the conventional developing device.

### (Comparison of Detection Accuracy)

Here, the detection accuracy of the magnetic permeability sensor 43 will be compared. A durability test was conducted by repetitively effecting image formation by using three developing devices consisting of the conventional developing device 32 (COMP. EMB. 1) shown in FIG. 9, a conventional developing device (COMP. EMB. 2) having the constitution of FIG. 9 from which the first area 70 is removed, and the developing device 42 (EMB. 1) shown in FIG. 1. Comparison of detected values of the magnetic permeability sensor 43 and actual toner contents from 0 sheets every 10,000 sheets was made and an occurrence of image defect was checked.

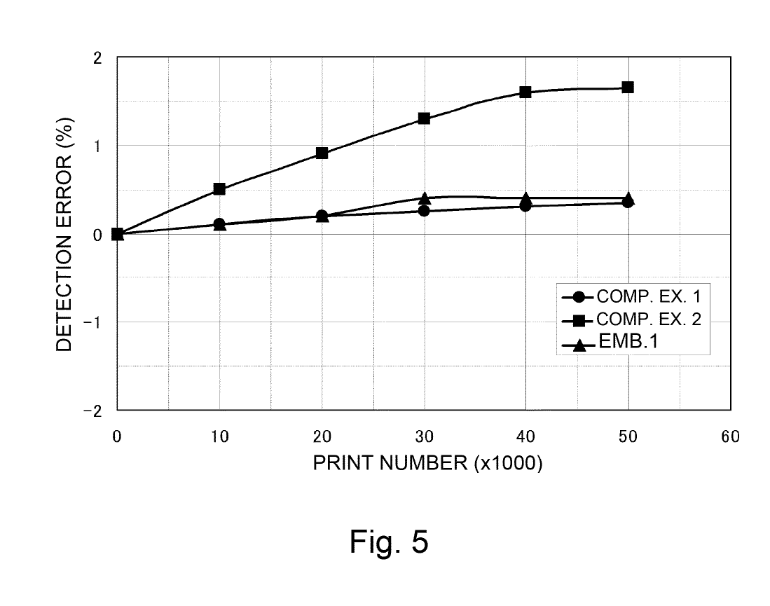

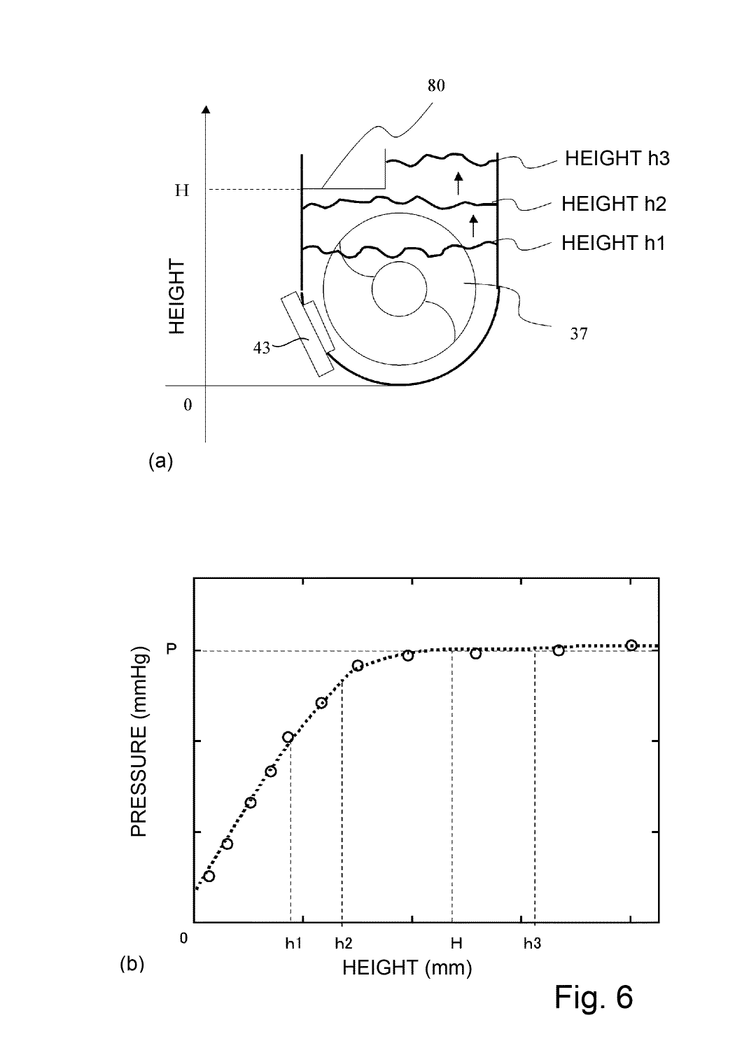

FIG. 5 is a graph of progression of the detection accuracy of the magnetic permeability sensor 43. In FIG. 5, the abscissa represents the number of sheets subjected to the image formation and the ordinate represents the detection accuracy (detection error) of the toner content. The values of the detection accuracy are plotted every 10,000 sheets. The detection accuracy is a difference between the actual toner content and the detected value of the magnetic permeability sensor. That is, the detection accuracy (detection error) is determined by the following equation.

Detection error (%)=(actual toner content)−(detected toner content of magnetic permeability sensor)

Incidentally, the toner content is a weight ratio between the carrier and the toner. Therefore, the comparison was made by taking a unit as %.

As shown in FIG. 5, in the conventional developing device free from the first area 70, the detection error was increased with the increasing number of sheets and exceeded 1.5%. This is attributable to changes in bulk density and flowability of the developer with progress of the durability test. Specifically, this is because there is no first area 70 and therefore even at the same actual toner content, the magnetic permeability sensor 43 is influenced by the change in bulk density and causes the erroneous detection.

In the conventional developing device 32, the first area 70 is present and therefore the magnetic permeability sensor 43 can perform accurate detection even when the bulk density of the developer is changed. For this reason, the detection error was 0.5% or less. However, from the number of sheets exceeding 38,000 sheets, the inconvenience of the image due to the toner aggregation occurred. Further, from the number of sheets exceeding 40,000 sheets, the supply of the developer to the developing sleeve 38 became unstable, so that the image defect occurred.

In the developing device 42 in this embodiment, the first area 80 was present and therefore the detection error of the magnetic permeability sensor 43 was 0.5% or less. Further, with respect to the flow path widthwise direction, the second area 81a higher when the first area 80 is present and therefore even after 50,000 sheets, different from the conventional developing device 32, the image defect did not occur.

### Second Embodiment

Second Embodiment of the developing device according to the present invention will be described.

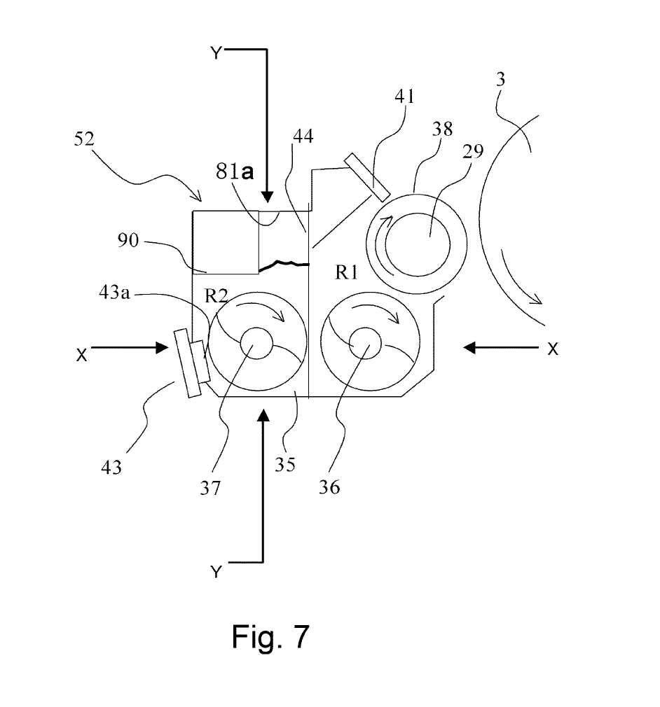

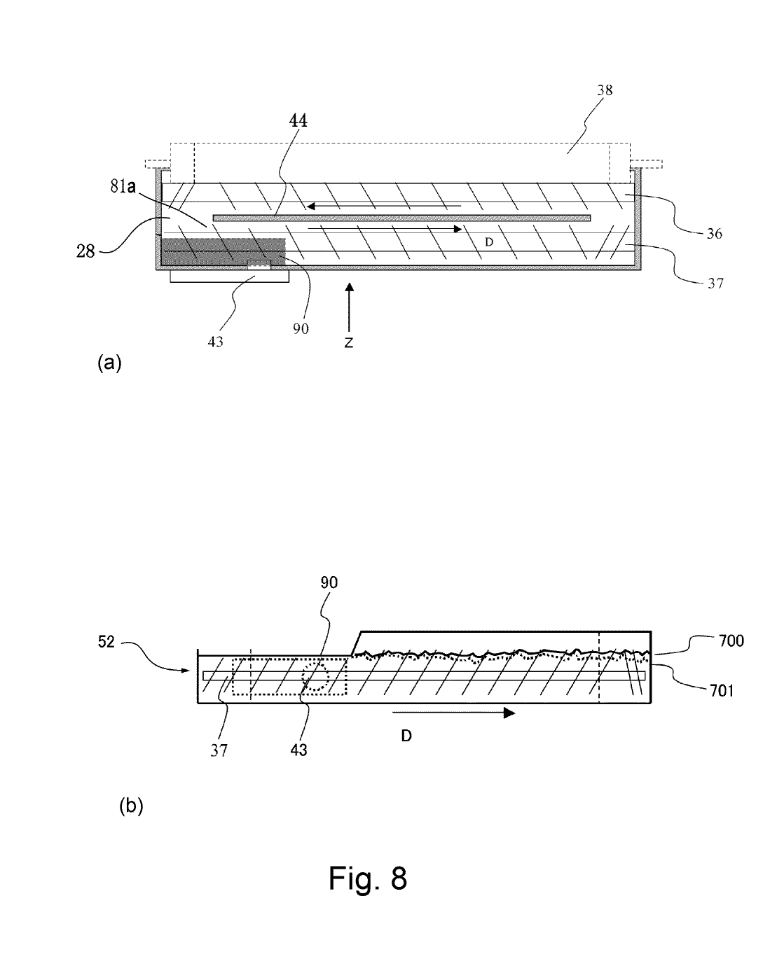

FIG. 7 is a schematic view of the developing device in this embodiment. As shown in FIG. 7, in a developing device 52 in this embodiment, first area 90 is provided in place of the first area 80 in the developing device 42 in First Embodiment. The developing device 52 is constituted so that it can be easily demounted from and mounted to the image forming apparatus. A process cartridge constitution in which the developing device 52, the photosensitive drum 3 and the charging means are integrally assembled so that it can be demounted and mounted. Incidentally, the developing device 42 may also be assembled into the process cartridge which can be easily demounted from and mounted to the image forming apparatus.

Part (a) of FIG. 8 is a sectional view of the developing device 52 taken along X-X line indicated in FIG. 7, and (b) of FIG. 8 is a sectional view of the developing device 52 taken along Y-Y line indicated in FIG. 7. Part (b) of FIG. 8 is a schematic longitudinal view of the developing device 52 as seen from 2 direction indicated in (a) of FIG. 8. As shown in (a) and (b) of FIG. 8, the first area 90 is continuously provided from a position, in which the first area 90 opposes the opening 28 which connects the stirring chamber R2 and the developing chamber R1, to vertically above the magnetic permeability sensor 43. The first area 90 is indicated by a dotted line in (a) of FIG. 8.

In (b) of FIG. 8, a flowing direction of the developer 35, a developer surface height 700 (solid line) and a developer surface height 701 (dotted line) are shown.

In the constitution of First Embodiment, the flow path is narrowed from an intermediate position of the feeding of the developer 35 (from the position of the first area 90). Therefore, although the inconvenience of the image does not occur by the presence of the second area 81a, the stagnation somewhat occurs. Particularly, when the process cartridge constitution is employed and the process cartridge is started to be demounted and tilted from the image forming apparatus, the developer is localized at the upstream side of the magnetic permeability sensor 43. There is an escape area of the developer and therefore the localization of the developer at the sensor upstream portion is gradually alleviated but the occurrence of the stagnation is not preferable.

In this embodiment, the developer is localized at the upstream side of the sensor portion when the process cartridge is demounted and tilted from the image forming apparatus but the flow path at the upstream side of the magnetic permeability sensor 43 provides a constant space, so that the stagnation does not occur. Thus, there is not stagnated developer and therefore the developer stored in the developing device can be used with no waste, so that it is possible to form a good image for a long term. Incidentally, a better effect can be achieved when the process cartridge constitution is employed but even a constitution other than the process cartridge constitution has an effect.

According to the present invention, by providing the first area in which the ceiling height of the flow path is lower than the developer surface height, the detection accuracy of the toner content detecting means is enhanced and at the same time by providing the second area in which the ceiling height of the flow path is higher than the developer surface height, the circulation of the developer in the developer container is keep at a constant level, so that a degree of the occurrence of the image inconvenience and defect can be suppressed.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 085769/2010 filed Apr. 2, 2010, which is hereby incorporated by reference.

What is claimed is:

1. A developing device comprising:
a developing container for containing a developer including toner and a carrier;
a feeding member for feeding the developer in said developing container through a feeding path; and
a detecting portion for detecting information on magnetic permeability of the developer in said developing container,
wherein a cross-section of said feeding path includes a first area and a second area which has a larger height than that of said first area, and said detection portion is provided vertically below said first area.

2. A developing device according to claim 1, wherein a ceiling of said first area is below a level of the developer in said second area when said feeding member is in operation.

3. A developing device according to claim 1, wherein said developer container includes a developing chamber and a stirring chamber which are connected through an opening, and
wherein the first area is provided along the feeding direction of the developer so that the first area extends vertically above from a position in which the first area opposes the opening to said detecting portion.
